(19) United States
(12) Patent Application Publication
(10) Pub. No.: US 2024/0098224 A1
(43) Pub. Date: Mar. 21, 2024

(54) MONITORING CAMERA INFORMATION TRANSMITTING DEVICE, MONITORING CAMERA INFORMATION RECEIVING DEVICE, MONITORING CAMERA SYSTEM, AND MONITORING CAMERA INFORMATION RECEIVING METHOD

(71) Applicant: Mitsubishi Electric Corporation, Tokyo (JP)

(72) Inventor: Keisuke SASAKI, Tokyo (JP)

(73) Assignee: Mitsubishi Electric Corporation, Tokyo (JP)

(21) Appl. No.: 18/274,213

(22) PCT Filed: Feb. 26, 2021
(86) PCT No.: PCT/JP2021/007232

§ 371 Date: Jul. 26, 2023

(51) Int. Cl. H04N 7/18; H04N 23/61; H04N 23/66; H04N 23/69

(52) U.S. Cl. CPC H04N 7/181; H04N 23/61; H04N 23/66; H04N 23/69

(57) ABSTRACT

A monitoring camera information receiving device includes a reception control unit to receive image analysis data an analyzing unit to analyze the image analysis data by referring to a camera link table and an image change table, and make an image control request for a host monitoring camera on the basis of the analysis result, and an image control unit to change a parameter related to image capturing of the host monitoring camera in accordance with the image control request, in which a detection region of a monitoring camera and identification information of a monitoring camera linked with the detection region are registered in the camera link table, the image change table defines a non-color condition for changing the parameter and a change of the parameter, and the analyzing unit makes the image control request in accordance with the change when the received image analysis data satisfies the non-color condition.

### TECHNICAL FIELD

The present disclosure relates to a monitoring camera information transmitting device, a monitoring camera information receiving device, a monitoring camera system, and a monitoring camera information receiving method.

### BACKGROUND ART

Patent Literature 1 discloses a technology in which, in a monitoring camera network including a plurality of monitoring cameras including a first monitoring camera and a second monitoring camera, the second monitoring camera acquires color information of a monitoring target captured by the first monitoring camera from the first monitoring camera in advance, and the second monitoring camera increases sensitivity or resolution with respect to the color information, so that the monitoring target can be clearly captured from when the monitoring target enters an imaging angle of view of the second monitoring camera.

### CITATION LIST

### Patent Literature

Patent Literature 1: JP 2006-295604 A

### SUMMARY OF INVENTION

### Technical Problem

According to the technique of Patent Literature 1, although information regarding color of a single monitoring target is taken into consideration, there is a problem that it is not possible to appropriately deal with a case where an event that satisfies a condition related to a characteristic other than color occurs. For example, in a case where a plurality of monitoring targets is predicted to enter a monitoring region of a host camera or a certain monitoring target is predicted to enter the monitoring region at a high speed, there is a problem that it is not possible to clearly capture images of these monitoring targets.

The present disclosure has been made to solve such a problem, and according to one aspect of the embodiment, an object of the present disclosure is to provide a monitoring camera information receiving device that changes a setting related to image capturing when an event that satisfies a condition related to a characteristic other than color of a monitoring target occurs.

### Solution to Problem

According to one aspect of a monitoring camera information receiving device according to an embodiment, a monitoring camera information receiving device includes:
a reception control unit to receive image analysis data via a communication network, the image analysis data being analysis data of an image captured by another monitoring camera;
an image analysis data analyzing unit to analyze the received image analysis data by referring to a camera link table and an image change table, and make an image control request for a host monitoring camera on the basis of a result of the analysis; and
an image control unit to change at least one parameter related to image capturing of the host monitoring camera in accordance with the image control request, in which
one or more detection regions of a monitoring camera connected to the communication network and identification information of a monitoring camera linked with each of the detection regions are registered in the camera link table,
the image change table defines a non-color condition for changing the at least one parameter and a change of the at least one parameter in a case where the non-color condition is satisfied, and the non-color condition includes a first condition related to a case where the number of mobile objects in an angle of view of the host monitoring camera is plural or a second condition related to a speed of a mobile object in the angle of view of the host monitoring camera, and
the image analysis data analyzing unit makes the image control request in accordance with the change when the received image analysis data satisfies the non-color condition.

### Advantageous Effects of Invention

According to one aspect of a monitoring camera information receiving device according to an embodiment, a setting related to image capturing can be changed when an event that satisfies a condition related to a characteristic other than color of a monitoring target occurs.

### BRIEF DESCRIPTION OF DRAWINGS

FIG. 1 is a system configuration example of a monitoring camera system including a monitoring camera information transmitting device and a monitoring camera information receiving device.

FIG. 2 is a block diagram illustrating a configuration example of the monitoring camera information transmitting device and a configuration example of the monitoring camera information receiving device.

FIG. 3A is a diagram illustrating an example of a detection region table.

FIG. 3B is a diagram in which detection regions are superimposed on an actual angle of view.

FIG. 4A is a diagram illustrating an operation by a deep learning inference processing unit.

FIG. 4B is a diagram illustrating an operation by the deep learning inference processing unit.

FIG. 4C is a diagram illustrating an operation by the deep learning inference processing unit.

FIG. 4D is a diagram illustrating an operation by the deep learning inference processing unit.

FIG. 5A is a plan view of a floor on which a plurality of cameras A to F is installed as viewed from above.

FIG. 5B is a diagram illustrating an image at an angle of view of the camera E.

FIG. 5C is a diagram illustrating an image at an angle of view of the camera D.

FIG. 5D is an example of a camera link table.

FIG. 6A is a diagram illustrating an example of image analysis data.

FIG. 6B is a diagram illustrating another example of the image analysis data.

FIG. 7 is a diagram illustrating an example of an image change table.

FIG. 8 is a diagram illustrating an operation example of processing of an image analysis data analyzing unit.

FIG. 9A is a diagram illustrating a configuration example of hardware of the monitoring camera information transmitting device and the monitoring camera information receiving device.

FIG. 9B is a diagram illustrating another configuration example of hardware of the monitoring camera information transmitting device and the monitoring camera information receiving device.

FIG. 10 is a flowchart of the monitoring camera and the monitoring camera information transmitting device.

FIG. 11 is a flowchart of the monitoring camera and the monitoring camera information receiving device.

FIG. 12 is a diagram illustrating still another example of the image change table.

### DESCRIPTION OF EMBODIMENTS

Hereinafter, various embodiments according to the present disclosure will be described in detail with reference to the drawings. Note that components denoted by the same reference numerals throughout the drawings have the same or similar configurations or functions.

### First Embodiment

<Configuration>

(Monitoring Camera System)

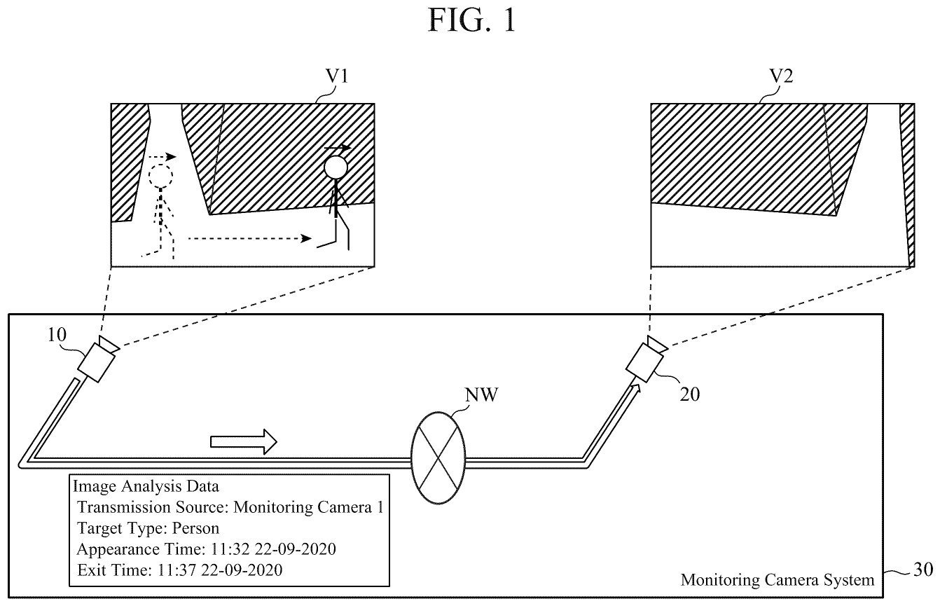

A system configuration of a monitoring camera system 30 according to a first embodiment will be described with reference to FIG. 1. FIG. 1 is a system configuration diagram of the monitoring camera system 30 according to the first embodiment. As illustrated in FIG. 1, the monitoring camera system 30 includes a monitoring camera 10 and a monitoring camera 20, and the monitoring camera 10 and the monitoring camera 20 are connected via a communication network NW. The monitoring camera 10 has a function of analyzing a captured image by deep learning, and can determine from an image V1 that a mobile object such as a person or a drone has entered the angle of view of the imaging unit of the monitoring camera 10. The monitoring camera 10 can also track the person who has entered and determine that the person has exited from the angle of view. Image analysis data analyzed by the monitoring camera 10 is transmitted to the communication network NW, and the monitoring camera 20 receives and analyzes the data, whereby an operating condition related to image quality of an image V2 captured by the monitoring camera 20 can be changed.

As illustrated in FIG. 1, the image analysis data transmitted to the communication network NW includes, for example, data indicating a camera name of a transmission source of the data, data indicating a target type indicating a type of a target appearing in the image, data indicating an appearance time indicating a time when the target appears within the angle of view, and data indicating an exit time indicating a time when the target exits from the angle of view.

A monitoring device (not illustrated) that monitors image data transmitted from the monitoring camera 10 and the monitoring camera 20 and a recording device (not illustrated) that records the image data may be connected to the communication network NW.

(Monitoring Camera and Monitoring Camera Information Transmitting Device)

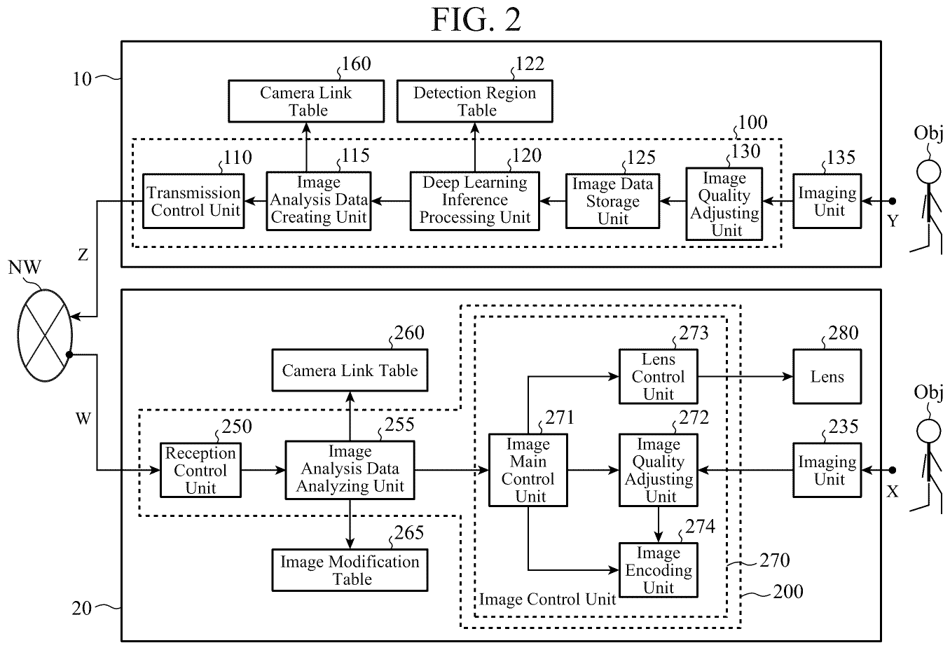

Next, configuration examples of the monitoring camera 10 and the monitoring camera 20 constituting the monitoring camera system 30 will be described with reference to FIG. 2. FIG. 2 is a block diagram illustrating configuration examples of the monitoring camera 10 and the monitoring camera 20 constituting the monitoring camera system 30. As illustrated in FIG. 2, the monitoring camera 10 receives visible light Y as an input, performs predetermined signal processing on data obtained from the visible light Y, and outputs a data series Z. In addition, as illustrated in FIG. 2, the monitoring camera 20 receives a data series W from the communication network NW as an input, performs predetermined signal processing on the data series W, and receives the visible light X as an input.

As illustrated in FIG. 2, the monitoring camera 10 includes an imaging unit 135, an information transmitting device 100 for the monitoring camera 10, a camera link table 160, and a detection region table 122. In addition, the information transmitting device 100 includes an image quality adjusting unit 130, an image data storage unit 125, a deep learning inference processing unit 120, an image analysis data creating unit 115, and a transmission control unit 110. Each component included in the monitoring camera 10 and the information transmitting device 100 will be described below with reference to FIG. 2.

The imaging unit 135 captures an image within an angle of view of the monitoring camera 10. Imaging data obtained by image capturing by the imaging unit 135 is sent to the image quality adjusting unit 130. The imaging unit 135 is implemented by, for example, an image sensor such as a charged coupled device (CCD) or a complementary metal oxide semiconductor (CMOS).

The image quality adjusting unit 130 performs various image quality adjustments such as hue adjustment by auto white balance (AWB), exposure correction by auto exposure (AE), focus adjustment by auto focus (AF), and sharpness adjustment. The image quality adjusting unit 130 performs image quality adjustment on imaging data sent from the imaging unit 135, and the image data with adjusted image quality is sent to the image data storage unit 125.

The image data storage unit 125 temporarily stores the image data sent from the image quality adjusting unit 130, and the image data stored in the image data storage unit 125 is referred to by the deep learning inference processing unit 120. Note that, in FIG. 2, the image data storage unit 125 is illustrated as a component included in the information transmitting device 100, but may be included as a component of the monitoring camera 10 instead of the component included in the information transmitting device 100.

The deep learning inference processing unit 120 holds a neural network learned in advance in such a way as to be capable of detecting a person and detecting movement of the person. The deep learning inference processing unit 120 has a function of detecting that a person appears in the image data, that the appeared person moves in the image, and that the appeared person exits from the image data, by performing deep learning inference processing on the image data acquired from the image data storage unit 125 using the learned neural network.

The detection region table 122 holds region information within the angle of view, and the region information is referred to by the deep learning inference processing unit 120. Appearance information of the person and exit information of the person detected by the inference of the deep learning inference processing unit 120 are associated with the region information. The detection region table 122 is implemented by, for example, a memory included in the monitoring camera 10.

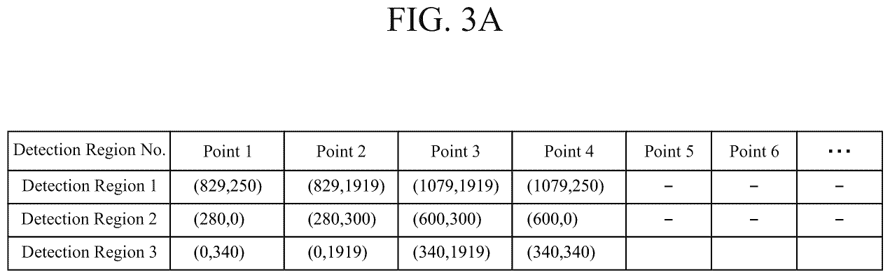

Here, the detection region table 122 will be described with reference to FIGS. 3A and 3B. FIG. 3A illustrates an example of the detection region table 122, and FIG. 3B illustrates a diagram in which detection regions are superimposed on an actual angle of view. In the example of FIG. 3A, Detection Region 1, Detection Region 2, and Detection Region 3 are registered. As for coordinates defining Detection Region 1, Coordinates 1 (829, 250), Coordinates 2 (829, 1919), Coordinates 3 (1079, 1919), and Coordinates 4 (1079, 250) are set. A rectangular region formed by these Coordinates 1 to 4 is defined as Detection Region 1. In the example of FIG. 3A, Coordinates defining each of Detection Region 2 and Detection Region 3 are also set. The detection region can be designated by a human hand when a monitoring camera is installed. FIG. 3B is a diagram in which Detection Region 1, Detection Region 2, and Detection Region 3 are superimposed on an actual angle of view.

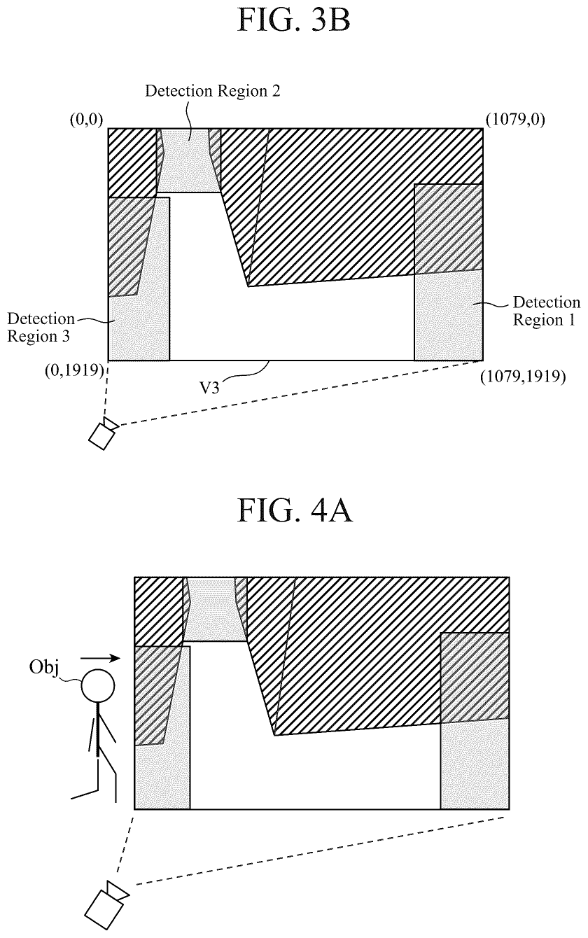

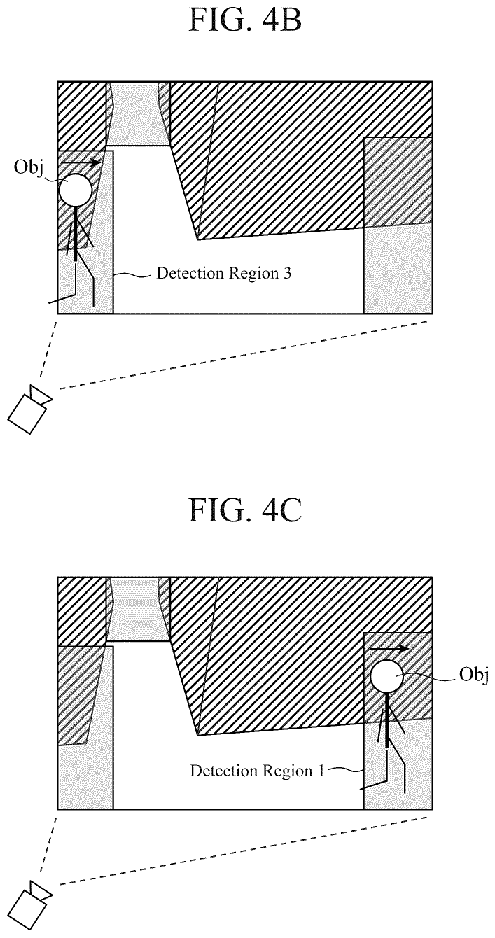

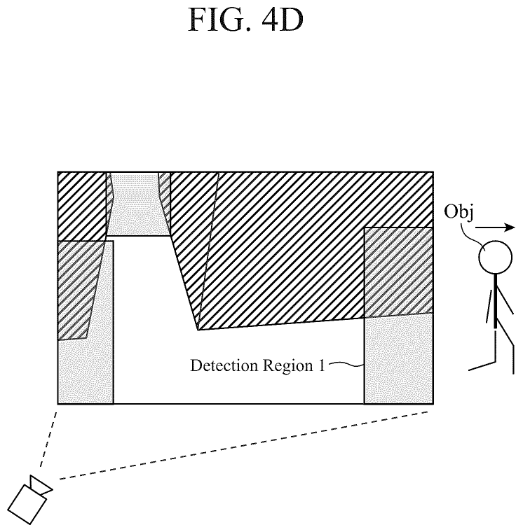

Next, examples of detection of appearance of a person, detection of movement of the person in an image, and detection of exit of the person implemented by the deep learning inference processing unit 120 will be described with reference to FIGS. 4A to 4D. According to FIG. 4A, a monitoring target Obj is not detected because it does not fall within the angle of view of the monitoring camera. Next, in FIG. 4B, when the monitoring target Obj enters the angle of view of the monitoring camera, the deep learning inference processing unit 120 detects the monitoring target Obj as a person, assigns an identification number for individually distinguishing the monitoring target Obj, and associates Detection Region 3 with the monitoring target Obj by referring to the region information acquired from the detection region table 122. The deep learning inference processing unit 120 transmits this detection information to the image analysis data creating unit 115. Next, as illustrated in FIG. 4C, the monitoring target Obj detected in FIG. 4B moves rightward and enters Detection Region 1, and then, as illustrated in FIG. 4D, the monitoring target Obj exits to the outside of the angle of view of the monitoring camera. The deep learning inference processing unit 120 associates Detection Region 1 by referring to the region information acquired from the detection region table 122. The deep learning inference processing unit 120 transmits information associating the detected monitoring target Obj with the detection region to the image analysis data creating unit 115.

In FIG. 2, the detection region set for each camera and a camera name (camera identification information) linked with the set detection region are registered in the camera link table 160, and the camera link table 160 is referred to by the image analysis data creating unit 115. The camera link table 160 is implemented by, for example, a memory included in the monitoring camera 10.

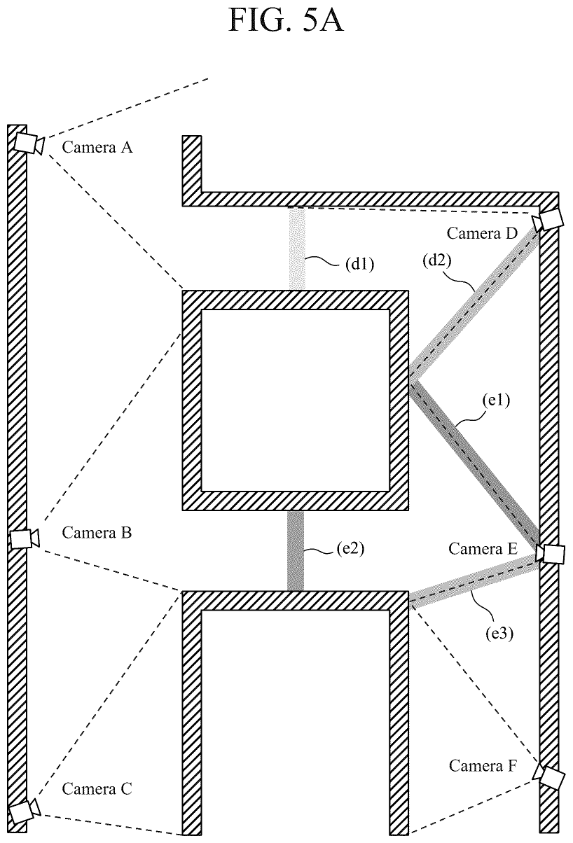

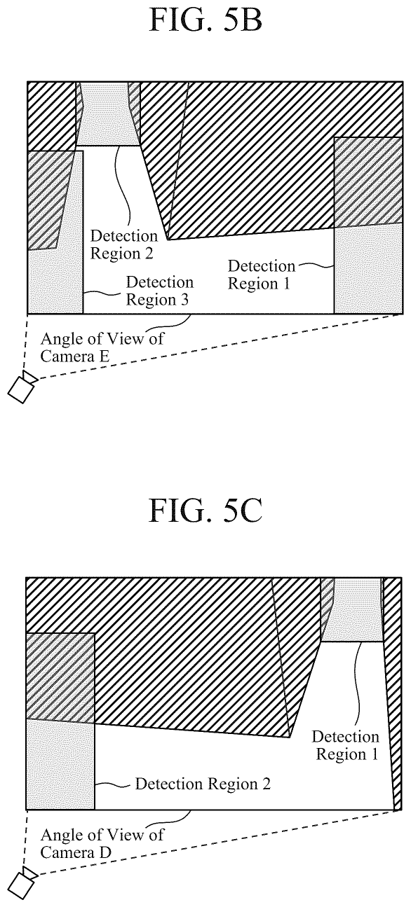

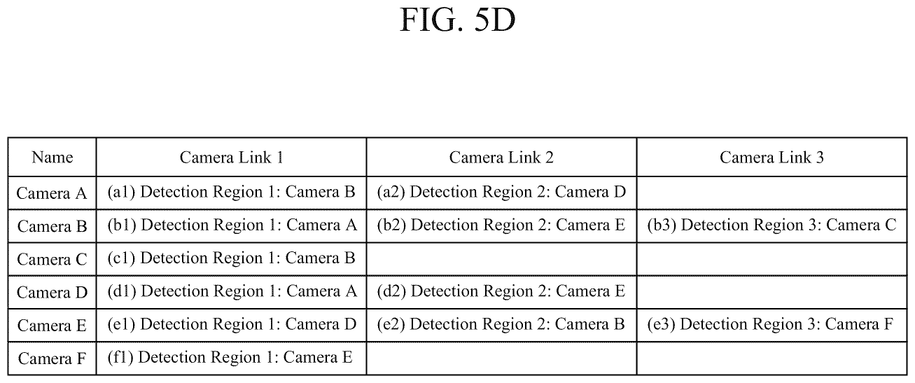

Here, a specific example of the camera link table 160 will be described with reference to FIGS. 5A to 5D. FIG. 5A is a plan view of a floor on which cameras A to F are installed as viewed from above. A broken line in FIG. 5A is a line for indicating a range of a horizontal angle of view of each camera. FIG. 5B is an image at the angle of view of the camera E, and FIG. 5C is an image at the angle of view of the camera D. FIG. 5D is an example of the camera link table 160. Hereinafter, the camera link setting of the camera D and the camera E in the camera link table 160 will be specifically described.

As illustrated in FIG. 5D, Detection Region 1 and the camera A are set in such a way as to be linked as Camera Link 1 of the camera D. The camera link means, with respect to a detection region set to a certain camera, a setting indicating another camera linked with this detection region. As illustrated in FIGS. 5C and 5A, because the camera installed ahead of Detection Region 1 of the camera D is the camera A, the camera A is set as the camera to be linked with respect to Detection Region 1 of the camera D.

As illustrated in FIG. 5D, Detection Region 2 and the camera E are set in such a way as to be linked as Camera Link 2 of the camera D. This is because the camera installed ahead of Detection Region 2 of the camera D is the camera E as illustrated in FIGS. 5C and 5A.

As illustrated in FIG. 5D, Detection Region 1 and the camera D are set in such a way as to be linked as Camera Link 1 of the camera E. This is because, as illustrated in FIGS. 5B and 5A, the camera installed ahead of Detection Region 1 of the camera E is the camera D.

As illustrated in FIG. 5D, Detection Region 2 and the camera B are set in such a way as to be linked as Camera Link 2 of the camera E. This is because the camera installed ahead of Detection Region 2 of the camera E is the camera B as illustrated in FIGS. 5B and 5A.

As illustrated in FIG. 5D, Detection Region 3 and the camera F are set in such a way as to be linked as Camera Link 3 of the camera E. This is because the camera installed ahead of Detection Region 3 of the camera E is the camera F as illustrated in FIGS. 5B and 5A.

In the camera link table, the link table for all the cameras may be incorporated in each camera, or only the link table for the host camera may be incorporated. In addition, the number of other cameras linked with the detection region of a certain camera is not necessarily one, and a plurality of cameras may be linked.

In FIG. 2, the image analysis data creating unit 115 creates image analysis data, by using the detection information transmitted from the deep learning inference processing unit 120, information of camera link acquired by referring to the camera link table 160, and the name of the host camera as the transmission source. The image analysis data creating unit 115 transmits the image analysis data to the transmission control unit 110.

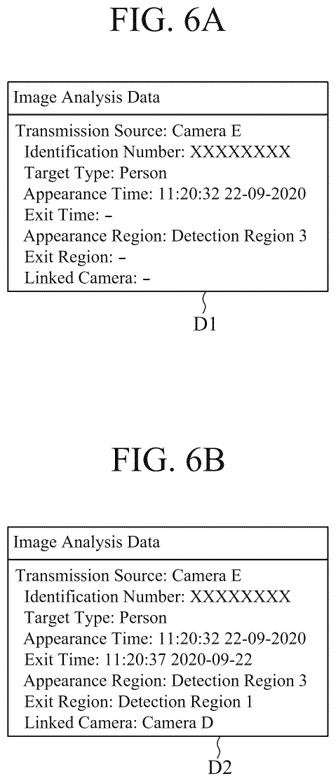

FIGS. 6A and 6B illustrate examples of the image analysis data created by the image analysis data creating unit 115. The image analysis data includes a camera name of a transmission source, an identification number for individually distinguishing the monitoring target, a target type, a time at which the monitoring target appears within the camera angle of view, a time at which the monitoring target exits the camera angle of view, a region in which the monitoring target appears within the camera angle of view, a region in which the monitoring target exits the camera angle of view, and a camera name linked with the region in which the monitoring target exits the camera angle of view. Specifically, the image analysis data D1 illustrated in FIG. 6A means that the monitoring camera E detects the appearance of a person to whom an identification number XXXXXXXX is assigned in Detection Region 3 at 11:20:32 on Sep. 22, 2020. In addition, the image analysis data D2 of FIG. 6B means that the monitoring camera E detects that the person to whom an identification number XXXXXXXX is assigned has exited Detection Region 1 at 11:20:37 on Sep. 22, 2020, and the camera linked with Exit Region 1 is the camera D.

In FIG. 2, the transmission control unit 110 broadcasts the image analysis data received from the image analysis data creating unit 115 to the communication network NW. Instead of the broadcast transmission, the transmission control unit 110 may unicast or multicast the image analysis data to one or more linked cameras.

(Monitoring Camera and Monitoring Camera Information Receiving Device)

Next, a configuration of the monitoring camera 20 will be described. As illustrated in FIG. 2, the monitoring camera 20 includes an information receiving device 200 for the monitoring camera 20, a camera link table 260, an image change table 265, an imaging unit 235, and a lens 280. The information receiving device 200 includes a reception control unit 250, an image analysis data analyzing unit 255, and an image control unit 270. The image control unit 270 includes an image main control unit 271, an image quality adjusting unit 272, a lens control unit 273, and an image encoding unit 274. Each component included in the monitoring camera 20 and an information receiving device 200 will be described below with reference to FIG. 2.

The reception control unit 250 receives the image analysis data transmitted from the monitoring camera 10 via the communication network NW, and transmits the received image analysis data to the image analysis data analyzing unit 255.

In the camera link table 260, the detection region of the camera and the camera name linked therewith are registered, and are referred to by the image analysis data analyzing unit 255. The camera link table 260 is implemented by, for example, a memory included in an information receiving device 200. A specific example of the camera link table 260 is a table as illustrated in FIG. 5D. That is, the camera link table 260 may have the same content as the camera link table 160. Alternatively, the camera link table 260 may hold only a table related to the host camera. For example, in a case of the monitoring camera F, from the table illustrated in FIG. 5D, a table including only items and rows of the camera F may be held.

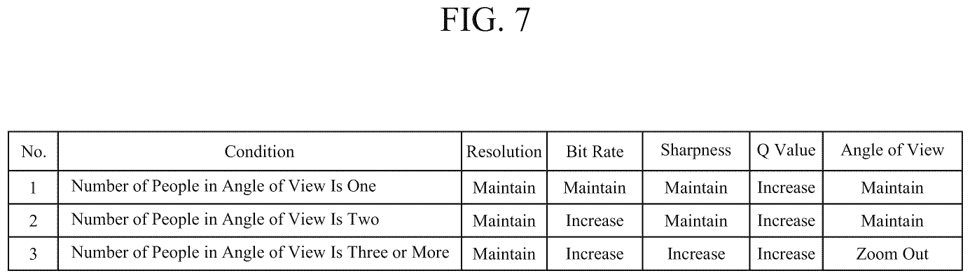

In the image change table 265, a predetermined condition (hereinafter may be referred to as a non-color condition) related to a characteristic other than color of the monitoring target, a method of changing a parameter related to image quality when each condition in the non-color condition is satisfied, a method of changing a parameter related to image encoding, and a method of changing the angle of view are defined. The image change table 265 is implemented by, for example, a memory included in information receiving device 200. Here, a specific example of the image change table 265 will be described with reference to FIG. 7. As illustrated in FIG. 7, a plurality of conditions regarding the characteristic of the number of people in the angle of view is defined in image change table 265. More specifically, Condition 1 that “the number of people in the angle of view is one”, Condition 2 that “the number of people in the angle of view is two”, and Condition 3 that “the number of people in the angle of view is equal to or more than three” are defined. Any of the conditions defines a case where the number of people in the angle of view increases. For example, to describe in accordance with Condition 2, Condition 2 includes a case where “the number of people in the angle of view is from zero to two” and a case where “the number of people in the angle of view is from one to two”, but does not include a case where “the number of people in the angle of view is from three to two”. In the example of FIG. 7, resolution and sharpness are illustrated as parameters related to image quality, and a bit rate and a quality factor (Q factor) are illustrated as parameters related to image encoding.

In the image change table 265, a method of changing the parameter related to image quality, the parameter related to image encoding, and the angle of view as compared with the setting in a case where the number of people in the angle of view is zero when each condition is satisfied is defined. For example, in a case where Condition 1 is satisfied, the setting of the camera is changed in such a way that the resolution is maintained, the bit rate is maintained, the sharpness is maintained, the Q factor is increased, and the angle of view is maintained. That is, the resolution, the bit rate, and the sharpness are the same as setting values in a case where the number of people in the angle of view is zero, the Q factor is increased higher than the setting value in the case where the number of people in the angle of view is zero, and the angle of view is maintained as it is as the setting in the case where the number of people in the angle of view is zero.

When Condition 2 is satisfied, the camera settings are changed in such a way that the resolution is maintained, the bit rate is increased, the sharpness is maintained, the Q factor is increased, and the angle of view is maintained. When Condition 3 is satisfied, the setting of the camera is changed in such a way that the resolution is maintained, the bit rate is increased, the sharpness is increased, the Q factor is increased, and the angle of view is zoomed out.

In the example of FIG. 7, the resolution remains unchanged even when any condition is satisfied, but the resolution may be changed in such a way as to be increased when any condition is satisfied. For example, when Condition 3 is satisfied, the resolution may be increased.

In a case where the number of people decreases, various parameters may be changed by individually setting a plurality of conditions such as a case where the number of people decreases from a larger number to two or a case where the number of people decreases from a larger number to one. Alternatively, in a case where the number of people in the angle of view becomes zero, various parameters may be returned to the default values (setting values in the case of zero people).

Returning to FIG. 2, the image analysis data analyzing unit 255 analyzes the image analysis data transmitted by the reception control unit 250, by referring to camera link information included in the camera link table 260 and image change information included in the image change table 265, and makes an image control request to the image main control unit 271 on the basis of the analysis result.

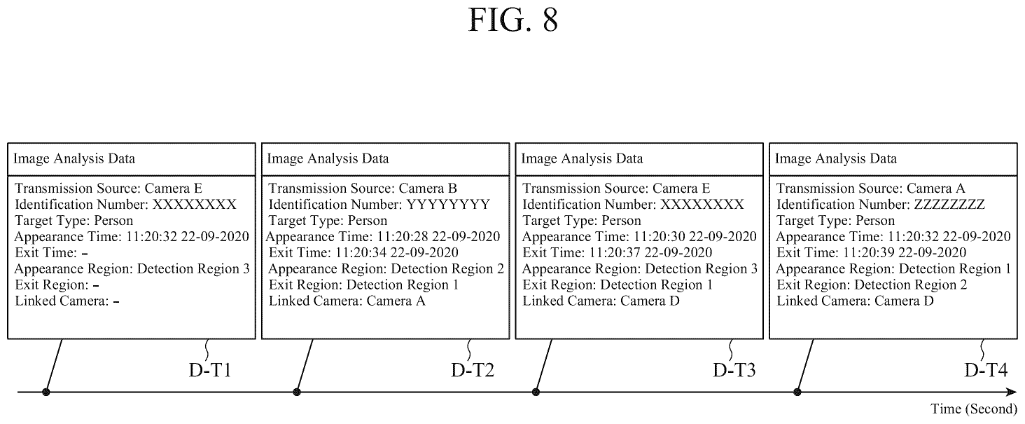

Here, the processing of the image analysis data analyzing unit 255 will be described with reference to FIG. 8 on the basis of a case where the camera D analyzes an image analysis data example using the camera link table 260 and the image change table 265. As illustrated in FIG. 8, it is assumed that the camera D receives image analysis data D-T1, image analysis data D-T2, image analysis data D-T3, and image analysis data D-T4 in this order from the communication network NW.

The image analysis data D-T1 indicates that a person (identification number: XXXXXXXX) appears in Detection Region 3 of the camera E. Because the image analysis data D-T1 is not necessary for the camera D, the image analysis data analyzing unit 255 of the camera D discards the received image analysis data D-T1.

The image analysis data D-T2 indicates that a person (identification number: YYYYYYYY) has exited from Detection Region 1 of the camera B, and the camera linked with Detection Region 1 that is the exit region is the camera A. Since the linked camera is the camera A, the image analysis data D-T2 is not necessary for the camera D. Thus, the image analysis data analyzing unit 255 of the camera D discards the received image analysis data D-T2.

The image analysis data D-T3 indicates that the person (identification number: XXXXXXXX) has exited from Detection Region 1 of the camera E, and the camera linked with Detection Region 1 that is the exit region is the camera D. Since the linked camera is the camera D, the image analysis data D-T3 is necessary for the camera D. According to the camera link table 260, the detection region in the angle of view of the camera D where a person who has exited from Detection Region 1 of the camera E appears is Detection Region 2. Assuming that there is no person within the current angle of view of the camera D, the image analysis data analyzing unit 255 of the camera D increases, in advance, the Q factor of Detection Region 2 in which the person (identification number: XXXXXXXX) is predicted to appear, in order to satisfy Condition 1 of the image change table 265. The encoding compression rate of the image can be lowered by increasing the Q factor, and thus a high-quality image can be obtained when or immediately after a person (identification number: XXXXXXXX) appears within the angle of view of the camera D by increasing the Q factor in advance.

The image analysis data D-T4 indicates that a person (identification number: ZZZZZZZZ) has exited from Detection Region 2 of the camera A, and the camera linked with Detection Region 2 that is the exit region is the camera D. Since the linked camera is the camera D, the image analysis data T4 is necessary for the camera D. According to the camera link table 260, the region at the angle of view of the camera D where the person who has exited from Detection Region 2 of the camera A appears is Detection Region 1. In a case where there is already one person (identification number: XXXXXXXX) within the current angle of view of the camera D, Condition 2 of the image change table 265 is satisfied. Accordingly, the image analysis data analyzing unit 255 of the camera D increases, in advance, the Q factor of Detection Region 1 in which the person (identification number: ZZZZZZZZ) is predicted to appear. The encoding compression rate of the image can be lowered by increasing the Q factor, and thus the image analysis data analyzing unit 255 of the camera D can obtain a high-quality image when or immediately after a person (identification number: ZZZZZZZZ) appears within the angle of view of the camera D by increasing the Q factor in advance. Furthermore, the image analysis data analyzing unit 255 of the camera D increases the bit rate in advance, so that the image quality of the entire screen is maintained even though the complexity in the angle of view increases due to an increase in the number of people.

In the example of FIG. 8, it is assumed that there is a plurality of persons in the angle of view of the camera D by entering, one by one, different detection regions in the angle of view of the camera D, but even in a case where it is assumed that there is a plurality of persons in the angle of view of the camera D by entering the same detection region in the angle of view of the camera D, the image analysis data analyzing unit 255 of the camera D may perform the same control as the above-described example using the image change table 265 of FIG. 7.

Returning to FIG. 2, the image main control unit 271 receives the image control request transmitted from the image analysis data analyzing unit 255 and, in accordance with the content of the image control request, transmits an image quality adjusting request to the image quality adjusting unit 272, transmits an angle-of-view control request (lens control request) to the lens control unit 273, and transmits an image encoding change request to the image encoding unit 274. On the other hand, imaging unit 235 captures a scene within the angle of view of the monitoring camera. The imaging unit 235 is implemented by, for example, an image sensor such as a charged coupled device (CCD) or a complementary metal oxide semiconductor (CMOS). Imaging data obtained by image capturing by the imaging unit 235 is sent to the image quality adjusting unit 272.

The lens control unit 273 receives the lens control request from the image main control unit 271. When receiving a request for changing the angle of view, the lens control unit 273 requests the lens 280 to perform angle of view control (lens control). The lens 280 receives the angle-of-view control request (lens control request) from the lens control unit 273, and changes a zoom magnification of the lens.

The image quality adjusting unit 272 executes an image processing request requested from the image main control unit 271 on the imaging data sent from the imaging unit 235. When receiving a request for resolution change, the image quality adjusting unit 272 changes the size of the imaging data to the specified resolution. When receiving a request for sharpness change, the image quality adjusting unit 272 adjusts the image quality of the imaging data with the specified sharpness.

The image encoding unit 274 performs image encoding on the image data whose image quality has been adjusted by the image quality adjusting unit 272. When receiving a request for bit rate change, the image encoding unit 274 performs image encoding on the image data at the specified bit rate. When receiving a request for Q factor change, the image encoding unit 274 performs image encoding on the image data with the specified Q factor. The image encoding unit 274 transmits the image data whose image quality has been adjusted by the image quality adjusting unit 272 or the image data encoded by the image encoding unit 274 to, for example, a monitoring device connected to the communication network NW.

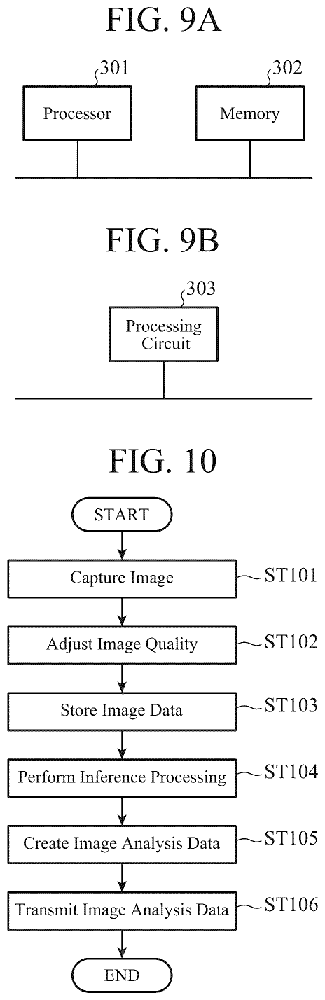

Next, a hardware configuration example of each of the information transmitting device 100 and the information receiving device 200 will be described with reference to FIGS. 9A and 9B. As an example, as illustrated in FIG. 9A, the information transmitting device 100 or the information receiving device 200 includes a processor 301 and a memory 302 connected to the processor 301. A program stored in the memory 302 is read and executed by the processor 301, thereby implementing the image quality adjusting unit 130, the deep learning inference processing unit 120, the image analysis data creating unit 115, and the transmission control unit 110 of the information transmitting device 100. The image data storage unit 125 is implemented by the memory 302. Note that, in a case where the image data storage unit 125 is a component of the monitoring camera 10 instead of the information transmitting device 100, the image data storage unit 125 is implemented by a memory, which is not illustrated, of the monitoring camera 10. Further, by reading and executing the program stored in the memory 302 by the processor 301, the reception control unit 250, the image analysis data analyzing unit 255, the image main control unit 271, the image quality adjusting unit 272, the lens control unit 273, and the image encoding unit 274 of the information receiving device 200 are implemented. The program is implemented as software, firmware, or a combination of software and firmware. Examples of the memory 302 include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, or a DVD.

As another example, as illustrated in FIG. 9B, the information transmitting device 100 or the information receiving device 200 includes a processing circuit 303 instead of the processor 301 and the memory 302. In this case, the image quality adjusting unit 130, the deep learning inference processing unit 120, the image analysis data creating unit 115, and the transmission control unit 110 of the information transmitting device 100 are implemented by the processing circuit 303. In addition, the reception control unit 250, the image analysis data analyzing unit 255, the image main control unit 271, the image quality adjusting unit 272, the lens control unit 273, and the image encoding unit 274 of the information receiving device 200 are implemented by the processing circuit 303. The processing circuit 303 is, for example, a single circuit, a composite circuit, a programmed processor, a parallel programmed processor, an application specific integrated circuit (ASIC), a field-programmable gate array (FPGA), or a combination thereof.

<Operation>

Next, operations of the monitoring camera 10 and the information transmitting device 100 of the monitoring camera 10 will be described with reference to FIG. 10.

In step ST101, the imaging unit 135 of the monitoring camera 10 captures an image within an angle of view of the monitoring camera 10. The imaging unit 135 transmits the imaging data obtained by the capturing to the image quality adjusting unit 130 of the information transmitting device 100.

In step ST102, the image quality adjusting unit 130 performs various image quality adjustments such as hue adjustment by AWB, exposure correction by AE, focus adjustment by AF, and sharpness adjustment. The image quality adjusting unit 130 transmits the image data on which the image quality adjustment has been performed to the image data storage unit 125.

In step ST103, the image data storage unit 125 temporarily stores the image data transmitted from the image quality adjusting unit 130.

In step ST104, the deep learning inference processing unit 120 acquires the image data stored in the image data storage unit 125, and performs deep learning inference processing on the acquired image data using the learned neural network. By the inference processing, it is detected that a person appears in the image data, the person who appears moves in the image, and the person who appears exits from the image data. The deep learning inference processing unit 120 refers to the detection region table 122, and transmits information in which the appearance information or the exit information of the person is associated with the region information of the detection region, to the image analysis data creating unit 115.

In step ST105, the image analysis data creating unit 115 creates the image analysis data, by using the detection information transmitted from the deep learning inference processing unit 120, the information of the camera link acquired by referring to the camera link table 160, and the name of the host camera as the transmission source. The image analysis data creating unit 115 transmits the image analysis data to the transmission control unit 110.

In step ST106, the transmission control unit 110 transmits the image analysis data received from the image analysis data creating unit 115 to the communication network NW.

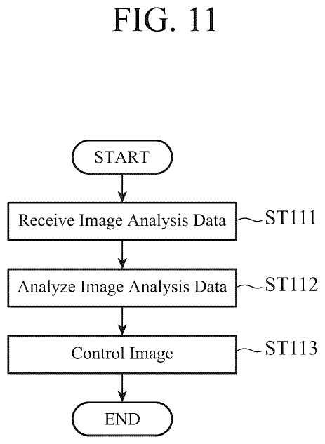

Next, operations of the monitoring camera 20 and the information receiving device 200 of the monitoring camera 20 will be described with reference to FIG. 11.

In step ST111, the reception control unit 250 receives the image analysis data transmitted from the monitoring camera 10 via the communication network NW, and transmits the received image analysis data to the image analysis data analyzing unit 255.

In step ST112, the image analysis data analyzing unit 255 analyzes the image analysis data transmitted by the reception control unit 250 by referring to the camera link table 260 and the image change table 265, and makes an image control request to the image main control unit 271 on the basis of the analysis result. Detection regions of monitoring cameras connected to the communication network NW and identification information of monitoring cameras linked with the detection regions are registered in the camera link table 260. In the image change table 265, a non-color condition for changing at least one parameter related to image capturing of the monitoring camera 20 and a change of the at least one parameter in a case where the non-color condition is satisfied are defined, and the non-color condition includes a condition related to a case where the number of mobile objects in the angle of view of the monitoring camera 20 is plural. Examples of parameters include resolution, bit rate, sharpness, Q factor, and angle of view. When the received image analysis data satisfies the non-color condition, the image analysis data analyzing unit 255 makes an image control request in accordance with the defined change.

In step ST113, the image control unit 270 receives the image control request transmitted from the image analysis data analyzing unit 255, and controls an image to be captured or an image captured by the monitoring camera 20 in accordance with the content of the image control request. That is, the image control unit 270 performs control in such a way as to change the value of the parameter in accordance with the content of the image control request. More specifically, the image main control unit 271 of the image control unit 270 receives the image control request transmitted from the image analysis data analyzing unit 255, and in accordance with the content of the image control request, transmits the image quality adjusting request to the image quality adjusting unit 272, transmits the lens control request to the lens control unit 273, and transmits the image encoding change request to the image encoding unit 274. The image quality adjusting unit 272 executes an image processing request requested from the image main control unit 271 on the imaging data obtained by image capturing by the imaging unit 235. The image encoding unit 274 performs image encoding on the image data whose image quality has been adjusted by the image quality adjusting unit 130. The lens control unit 273 receives the lens control request from the image main control unit 271. When receiving a request for changing the angle of view, the lens control unit 273 requests the lens 280 to perform lens control. The lens 280 receives the lens control request from the lens control unit 273, and changes the zoom magnification of the lens.

The monitoring camera information transmitting device, the monitoring camera information receiving device, or the monitoring camera system considering the characteristic of the number of mobile objects as described above can be widely used in a system that detects movement of a person. For example, it can be used in a system for monitoring a getting-off place of an escalator that starts an operation when a person approaches the escalator. In such an escalator monitoring system, the monitoring camera information receiving device can adjust, in advance, the image quality of the camera that monitors the getting-off place of the escalator by receiving an operation signal of the escalator.

Furthermore, the above-described monitoring camera information receiving device 200 can also be used in a system that monitors a landing hall of an elevator. In such an elevator monitoring system, the monitoring camera information receiving device can adjust, in advance, the image quality of the camera that monitors the landing hall of a stop floor of the elevator by receiving a stop floor signal of the elevator.

In addition, the monitoring camera system 30 including the monitoring camera information transmitting device 100 and the monitoring camera information receiving device 200 described above can also be used as a system for monitoring a moving device other than a person, such as an automobile, an automatic conveyance device, or a drone.

As described above, the monitoring camera information transmitting device 100 can detect the appearance of a person, detect that the person moves in the image, and detect the exit of the person by deep learning. By configuring the monitoring camera information transmitting device 100 in such a way as to transmit the image analysis data based on these detections to the communication network NW, the monitoring camera information receiving device 200 that has received the image analysis data can change to image quality suitable for the number of people appearing within an angle of view or suitable for an appearance position of a person appearing within the angle of view before the person appears within the angle of view of a monitoring camera connected to the monitoring camera information receiving device 200, and can clearly capture an image of the person from the time when the person enters the imaging angle of view.

### Second Embodiment

In the above-described first embodiment, the example of the image change table 265 for adjusting the image of the monitoring camera by the characteristic of the number of people in the angle of view has been disclosed, but the monitoring camera system may be modified in such a way as to adjust the image of the monitoring camera by a characteristic of moving speed of a person.

In order to adjust the image of the monitoring camera in accordance with the moving speed of a person, the learned neural network held by the deep learning inference processing unit 120 of the monitoring camera information transmitting device 100 further performs preliminary learning in such a way that it is possible to detect that the person is moving at a high speed from the size of the person within the angle of view and the moving amount of the person per unit time. Then, the deep learning inference processing unit 120, by performing deep learning inference processing on image data acquired from the image data storage unit 125, has a function of detecting that the person is moving at a high speed in addition to detecting the appearance of the person in the image data, the movement of the appearing person in the image data, and the exit of the appearing person from the image data, as in the first embodiment. The deep learning inference processing unit 120 transmits these pieces of detection information to the image analysis data creating unit 115.

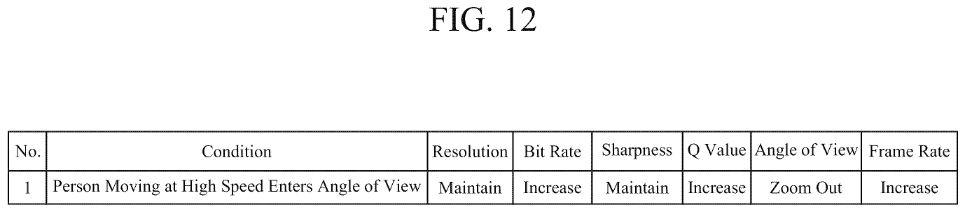

In order to adjust the image of the monitoring camera in accordance with the moving speed of the person, the image analysis data analyzing unit 255 of the monitoring camera information receiving device 200 refers to, for example, an image change table as illustrated in FIG. 12. In FIG. 12, a setting change condition that a person moving at a high speed enters the angle of view is defined as Condition 1 of the image change table. The average walking speed of an adult is approximately 1.3 [m/s], and thus any numerical value equal to or more than 1.4 [m/s] may be used as a reference of whether or not the speed is high. In the image change table of FIG. 12, as setting changes when Condition 1 is satisfied, setting changes are set in such a way that the resolution is maintained, the bit rate is increased, the sharpness is maintained, the Q factor is increased, the angle of view is zoomed out, and the frame rate is increased. Note that the image change table in FIG. 12 may be integrated with or separated from the image change table in FIG. 7.

As described above, by configuring the monitoring camera information transmitting device 100 in such a way as to be capable of detecting a person moving at a high speed by the deep learning, and to transmit the image analysis data obtained by the monitoring camera information transmitting device 100 to the communication network NW, the monitoring camera information receiving device 200 that has received the image analysis data can change to image quality suitable for the person moving at a high speed before the person appears within an angle of view of a monitoring camera connected to the monitoring camera information receiving device 200. Thus, it is possible to clearly capture an image of the person from when the person enters the imaging angle of view.

### SUPPLEMENTARY NOTE

Some aspects of the various embodiments described above are summarized below.

### Supplementary Note 1

A monitoring camera information receiving device (200) according to Supplementary Note 1 includes: a reception control unit (250) to receive image analysis data via a communication network, the image analysis data being analysis data of an image captured by another monitoring camera (10); an image analysis data analyzing unit (255) to analyze the received image analysis data by referring to a camera link table (260) and an image change table (265), and make an image control request for a host monitoring camera (20) on the basis of a result of the analysis; and an image control unit (270) to change at least one parameter related to image capturing of the host monitoring camera in accordance with the image control request, in which one or more detection regions of a monitoring camera connected to the communication network and identification information of a monitoring camera linked with each of the detection regions are registered in the camera link table, the image change table defines a non-color condition for changing the at least one parameter and a change of the at least one parameter in a case where the non-color condition is satisfied, and the non-color condition includes a first condition related to a case where the number of mobile objects in an angle of view of the host monitoring camera is plural or a second condition related to a speed of a mobile object in the angle of view of the host monitoring camera, and the image analysis data analyzing unit makes the image control request in accordance with the change when the received image analysis data satisfies the non-color condition.

### Supplementary Note 2

A monitoring camera information receiving device according to Supplementary Note 2 is the monitoring camera information receiving device according to Supplementary Note 1, in which the image control unit includes: an image main control unit (271) to receive the image control request, and transmit an image quality adjusting request that requests adjustment of image quality, an angle-of-view control request that requests control of an angle of view, or an image encoding change request that requests a change of image encoding; an image quality adjusting unit (272) to receive the image quality adjusting request and adjust the image quality; a lens control unit (273) to receive the angle-of-view control request and adjust the angle of view; and an image encoding unit (274) to receive the image encoding change request and change a method of the image encoding.

### Supplementary Note 3

A monitoring camera information transmitting device (100) according to Supplementary note 3 includes: a deep learning inference processing unit (120) to hold a neural network learned in advance in such a way as to be capable of detecting a mobile object or detecting movement of a mobile object, and perform deep learning inference processing on imaging data obtained by image capturing by a monitoring camera (10), the deep learning inference processing unit to refer to a detection region table holding region information within an angle of view, detect appearance, movement, or exit of the mobile object in a detection region in the image data, and output detection information; an image analysis data creating unit (115) to create, by referring to a camera link table in which one or more detection regions of a monitoring camera and identification information of a monitoring camera linked with each of the detection regions are registered, image analysis data including a detection region in which appearance, movement, or exit of the mobile object included in the detection information is detected, identification information of another monitoring camera (20) linked with the detection region, and identification information of a host monitoring camera (10); and a transmission control unit (110) to transmit the created image analysis data to a communication network.

### Supplementary Note 4

A monitoring camera information transmitting device according to Supplementary Note 4 is the monitoring camera information transmitting device according to Supplementary Note 3, in which the deep learning inference processing unit is capable of detecting that the mobile object moves at a speed equal to or more than 1.4 [m/s] by performing the deep learning inference processing.

### Supplementary Note 5

A monitoring camera system (30) according to Supplementary Note 5 includes: the monitoring camera information receiving device according to Supplementary Note 1 or 2; and the monitoring camera information transmitting device according to Supplementary Note 3 or 4.

### Supplementary Note 6

A monitoring camera information receiving method according to Supplementary Note 6 includes: a step (ST111) of receiving image analysis data via a communication network, the image analysis data being analysis data of an image captured by another monitoring camera (10); a step (ST112) of analyzing the received image analysis data by referring to a camera link table and an image change table, and making an image control request for a host monitoring camera (20) on the basis of a result of the analysis, in which one or more detection regions of a monitoring camera connected to the communication network and identification information of a monitoring camera linked with each of the detection regions are registered in the camera link table, the image change table defines a non-color condition for changing at least one parameter related to image capturing of the host monitoring camera and a change of the at least one parameter in a case where the non-color condition is satisfied, and the non-color condition includes a first condition related to a case where the number of mobile objects in an angle of view of the host monitoring camera is plural or a second condition related to a speed of a mobile object in the angle of view of the host monitoring camera, the step including making the image control request in accordance with the change when the received image analysis data satisfies the non-color condition; and a step (ST113) of changing the at least one parameter in accordance with the image control request.

Note that the embodiments can be combined, and each of the embodiments can be appropriately modified or omitted.

### INDUSTRIAL APPLICABILITY

A monitoring camera information receiving device according to the present disclosure can be mounted on a monitoring camera and used as the monitoring camera.

### REFERENCE SIGNS LIST

10: monitoring camera, 20: monitoring camera, 30: monitoring camera system, 100: information transmitting device, 110: transmission control unit, 115: image analysis data creating unit, 120: deep learning inference processing unit, 122: detection region table, 125: image data storage unit, 130: image quality adjusting unit, 135: imaging unit, 160: camera link table, 200: information receiving device, 235: imaging unit, 250: reception control unit, 255: image analysis data analyzing unit, 260: camera link table, 265: image change table, 270: image control unit, 271: image main control unit, 272: image quality adjusting unit, 273: lens control unit, 274: image encoding unit, 280: lens, 301: processor, 302: memory, 303: processing circuit

1. A monitoring camera information receiving device, comprising:
reception control circuitry to receive image analysis data via a communication network, the image analysis data being analysis data of an image captured by another monitoring camera;
image analysis data analyzing circuitry to analyze the received image analysis data by referring to a camera link table and an image change table, and make an image control request for a host monitoring camera on a basis of a result of the analysis; and
image control circuitry to change at least one parameter related to image capturing of the host monitoring camera in accordance with the image control request, wherein
one or more detection regions of a monitoring camera connected to the communication network and identification information of a monitoring camera linked with each of the detection regions are registered in the camera link table,
the image change table defines a non-color condition for changing the at least one parameter and a change of the at least one parameter in a case where the non-color condition is satisfied, and the non-color condition includes a first condition related to a case where the number of mobile objects in an angle of view of the host monitoring camera is plural or a second condition related to a speed of a mobile object in the angle of view of the host monitoring camera, and
the image analysis data analyzing circuitry makes the image control request in accordance with the change when the received image analysis data satisfies the non-color condition.

2. The monitoring camera information receiving device according to claim 1, wherein
the image control circuitry includes:
image main control circuitry to receive the image control request, and transmit an image quality adjusting request that requests adjustment of image quality, an angle-of-view control request that requests control of an angle of view, or an image encoding change request that requests a change of image encoding;
image quality adjusting circuitry to receive the image quality adjusting request and adjust the image quality;
lens control circuitry to receive the angle-of-view control request and adjust the angle of view; and
image encoding circuitry to receive the image encoding change request and change a method of the image encoding.

3. A monitoring camera information transmitting device, comprising:
deep learning inference processing circuitry to hold a neural network learned in advance in such a way as to be capable of detecting a mobile object or detecting movement of a mobile object, and perform deep learning inference processing on imaging data obtained by image capturing by a monitoring camera, the deep learning inference processing circuitry to refer to a detection region table holding region information within an angle of view, detect appearance, movement, or exit of the mobile object in a detection region in the image data, and output detection information;
image analysis data creating circuitry to create, by referring to a camera link table in which one or more detection regions of a monitoring camera and identification information of a monitoring camera linked with each of the detection regions are registered, image analysis data including a detection region in which appearance, movement, or exit of the mobile object included in the detection information is detected, identification information of another monitoring camera linked with the detection region, and identification information of a host monitoring camera; and
transmission control circuitry to transmit the created image analysis data to a communication network.

4. The monitoring camera information transmitting device according to claim 3, wherein the deep learning inference processing circuitry is capable of detecting that the mobile object moves at a speed equal to or more than 1.4 [m/s] by performing the deep learning inference processing.

5. A monitoring camera system, comprising:
the monitoring camera information receiving device according to claim 1; and
a monitoring camera information transmitting device, comprising:
deep learning inference processing circuitry to hold a neural network learned in advance in such a way as to be capable of detecting a mobile object or detecting movement of a mobile object, and perform deep learning inference processing on imaging data obtained by image capturing by a monitoring camera, the deep learning inference processing circuitry to refer to a detection region table holding region information within an angle of view, detect appearance, movement, or exit of the mobile object in a detection region in the image data, and output detection information;
image analysis data creating circuitry to create, by referring to a camera link table in which one or more detection regions of a monitoring camera and identification information of a monitoring camera linked with each of the detection regions are registered, image analysis data including a detection region in which appearance, movement, or exit of the mobile object included in the detection information is detected, identification information of another monitoring camera linked with the detection region, and identification information of a host monitoring camera; and
transmission control circuitry to transmit the created image analysis data to a communication network.

6. A monitoring camera information receiving method, comprising:
receiving image analysis data via a communication network, the image analysis data being analysis data of an image captured by another monitoring camera;
analyzing the received image analysis data by referring to a camera link table and an image change table, and making an image control request for a host monitoring camera on a basis of a result of the analysis, wherein one or more detection regions of a monitoring camera connected to the communication network and identification information of a monitoring camera linked with each of the detection regions are registered in the camera link table, the image change table defines a non-color condition for changing at least one parameter related to image capturing of the host monitoring camera and a change of the at least one parameter in a case where the non-color condition is satisfied, and the non-color condition includes a first condition related to a case where the number of mobile objects in an angle of view of the host monitoring camera is plural or a second condition related to a speed of a mobile object in the angle of view of the host monitoring camera;
making the image control request in accordance with the change when the received image analysis data satisfies the non-color condition; and
changing the at least one parameter in accordance with the image control request.
